(19) United States
(12) Patent Application Publication
(10) Pub. No.: US 2018/0340052 A1
(43) Pub. Date: Nov. 29, 2018

(54) BIAXIAL PTFE GASKET MATERIAL WITH HIGH PURITY FILLER

(71) Applicant: Garlock Sealing Technologies, LLC, Palmyra, NY (US)

(72) Inventors: Stefan Pitolaj, Palmyra, NY (US); Joseph D. Young, Palmyra, NY (US)

(21) Appl. No.: 15/988,812

(22) Filed: May 24, 2018

Related U.S. Application Data
(60) Provisional application No. 62/510,524, filed on May 24, 2017.

(51) Int. Cl. C08K 3/36; C08K 3/22; F16J 15/10

(52) U.S. Cl. CPC C08K 3/36; C08K 2003/2244; F16J 15/102; C08K 3/22

(57) ABSTRACT

A gasket material comprising polytetrafluoroethylene (PTFE) and high purity filler is described. The gasket material can include from 50 to 60 wt % PTFE and from 40 to 50 wt % high purity filler. The high purity filler can be high purity quartz, such as wherein the filler comprises greater than or equal to 99.996% quartz as the primary filler material. The PTFE can be full density PTFE. The gasket material can be provided in the form of a sheet, and can exhibit biaxial material properties. A core metal sheet can be encapsulated within the gasket material sheet, such as a corrugated metal sheet. Annular gasket seals can be formed from the gasket material sheet.

### CROSS-REFERENCE TO RELATED APPLICATIONS

The present application claims priority to U.S. Provisional Patent Application No. 62/510,524, filed May 24, 2017, the entirety of which is hereby incorporated by reference

### TECHNICAL FIELD

The present application relates to gasket material suitable for use in applications where high purity seals are required to maintain the purity of the material being processed, and more specifically to gasket material including full density PTFE and high purity filler, such as high purity quartz.

### BACKGROUND

Many industrial processes require that certain equipment used in the process be made from high level purity material in order to prevent contamination of process materials used therein. For example, in the silicon manufacturing and processing industry, gasket seals used in and around the reactor must have the desired mechanical and chemical properties (e.g., chemical compatibility, low creep, effective sealing, etc.) and also be made using high purity materials so as to not contaminate process materials that come into contact with the gasket seals. In some cases, gasket materials that otherwise provide the desired mechanical and chemical properties cannot be used because of the insufficient purity level of filler material used in the gasket material. When gaskets with less than desirable purity levels are used, production yields are reduced due to product contamination and profit is adversely affected.

Conversely, some gasket materials have the desired purity needed for the application, but do not possess the required mechanical and/or chemical properties required for the application and/or which allows for gasket reuse. For example, gaskets made from virgin PTFE have the desired purity levels for silicon manufacturing and processing, but do not exhibit the mechanical and chemical properties necessary for gasket reuse. The ability to reuse a gasket is highly desirable in the industry, as it allows for faster return of the system to operation state between changeovers, a corresponding reduction in downtime, and reduction in operating costs.

Even when high purity gaskets possess the desired mechanical and chemical properties, they may still lack the ability to be reused. Gaskets made from, for example, expanded PTFE have good sealing properties and may meet purity requirements, but once compressed do not regain their original shape and therefore cannot be used more than once.

Accordingly, a need exists for a reusable gasket material having a high level of purity and that also exhibits the chemical and physical characteristics necessary for effective sealing.

### SUMMARY

This Summary is provided to introduce a selection of concepts in a simplified form that are further described below in the Detailed Description. This Summary, and the foregoing Background, is not intended to identify key aspects or essential steps of the claimed subject matter. Moreover, this Summary is not intended for use as an aid in determining the scope of the claimed subject matter.

Described herein are various embodiments of a gasket material having the chemical and mechanical properties desired for gasket seals and which also provide the required high level of material purity such that the gasket seals can be used in processes requiring high purity levels (e.g., silicon manufacturing). In some embodiments, the gasket material comprises PTFE and filler, wherein the filler is high purity quartz. High purity quartz generally includes filler material that is 99.996% quartz or greater. In some embodiments, the PTFE component is full density PTFE. In some embodiments, the gasket material comprises from 50 to 55 wt % PTFE and from 45 to 50 wt % high purity filler. The gasket material described herein can be used to form gasket seals.

### BRIEF DESCRIPTION OF THE DRAWINGS

Non-limiting and non-exhaustive embodiments of the disclosed gasket material, including the preferred embodiment, are described with reference to the following figures, wherein like reference numerals refer to like parts throughout the various views, unless otherwise specified.

FIG. 1 illustrates a cross-sectional view of a gasket material according to various embodiments described herein.

### DETAILED DESCRIPTION

Embodiments are described more fully below with reference to the accompanying Figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following Detailed Description is, therefore, not to be taken in a limiting sense.

The gasket material described herein generally includes a polytetrafluoroethylene (PTFE) component and a filler component. In some embodiments, the PTFE component is in the form of a matrix and the filler component is homogenously dispersed throughout the PTFE matrix. In some embodiments, the PTFE component can be from 50 to 60 wt % of the gasket material, while the filler can be from 40 to 50 wt % of the gasket material.

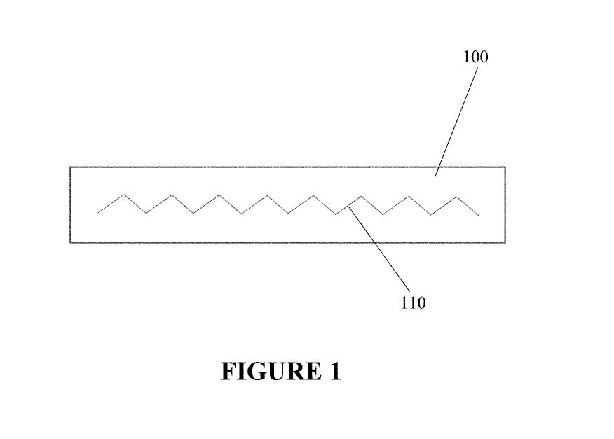

While in some embodiments the gasket material includes only PTFE and filler, other embodiments of the gasket material disclosed herein may include additional components. For example, in some embodiments, the gasket material further includes a core sheet material encapsulated by the PTFE and filler components. The core sheet material can be any suitable core sheet material, including, for example, a corrugated metal core sheet. FIG. 1 illustrates a gasket material 100 comprising a corrugated metal core sheet 110 encapsulated within the gasket material 100 of PTFE and filler. In some embodiments, the shape and orientation of the corrugated metal core sheet within the gasket material is similar or identical to the core sheet shown in U.S. Published Patent Application No. 2005/0116427, the entirety of which is hereby incorporated by reference. As shown in the '427 patent application, the corrugated shape forms concentric rings of peaks and valleys. Other documents showing a similar corrugated metal core sheet embedded within a gasket material include U.S. Pat. Nos. 5,421,594; 5,785,322; and 6,092,811, each of which is hereby incorporated by reference it is entirety. The corrugated metal core sheet design can provide greater resiliency than a flat homogenous gasket material alone. The resiliency of the metal core can result in a gasket that continues to provide compressive forces on the gasket material against mating flanges when used in that application. The compressive force maintains sealing forces against the flanges even as/if the soft gasket material creeps or takes compression set.

In some embodiments, the PTFE component is full density PTFE, meaning the PTFE has a high density and low porosity relative to other types of PTFE, such as expanded PTFE. The use of full density PTFE over other types of PTFE can help to make the gasket material reusable. For example, when expanded PTFE is used in gasket materials, the gasket material generally exhibits good compressibility and sealing characteristics in the first use. However, the expanded PTFE does not regain its original shape after being compressed, and thus cannot be reused. To the contrary, the gasket made from full density PTFE as described herein exhibits good sealing properties and also generally retains its shape such that when a gasket material including full density PTFE is removed from compression (such as from between two pipe segments), the gasket can be reused under compression again and still provide good sealing characteristics. In some embodiments, the gasket material described herein using full density PTFE can be used for greater than three compressive loading cycles.

The filler component of the gasket material can generally be a high purity filler material that minimizes or eliminates components that are undesirable or prohibited in industrial manufacturing processes. In some embodiments, the high purity filler component contains greater than or equal to 99.996% of a primary filler material, and less than or equal to 0.004% of contaminant material. In some embodiments, the primary filler material of the high purity filler is quartz (i.e., the high purity filler material includes greater than or equal to 99.996% quartz as the primary filler material). Previously known quartz fillers generally include, at best, 99.5% quartz material. The higher level of quartz in the high purity filler material minimizes or eliminates undesirable components from the filler, such as Sulphur or other mineral contaminants. Table 1 provides the chemical composition for various high purity quartz suitable for use in the gasket material described herein.

TABLE 1

| Element | Symbol | Filler 1 | Filler 2 | Filler 3 | Filler 4 | Filler 5 | Filler 6 |
|---|---|---|---|---|---|---|---|
| Aluminum | Al | 23.00 | 21.00 | 14.000 | 8.000 | 8.000 | 8.000 |
| Boron | B | n/a | n/a | 0.100 | 0.050 | 0.050 | 0.050 |
| Calcium | Ca | 0.50 | 0.50 | 0.600 | 0.700 | 0.700 | 0.400 |
| Chromium | Cr | 0.02 | 0.02 | 0.006 | 0.007 | 0.003 | 0.001 |
| Cobalt | Co | 0.01 | 0.01 | n/a | n/a | n/a | n/a |
| Copper | Cu | 0.03 | 0.02 | 0.028 | 0.004 | 0.001 | 0.001 |
| Iron | Fe | 1.00 | 0.50 | 0.300 | 0.300 | 0.200 | 0.050 |
| Potassium | K | 0.40 | 0.60 | 0.700 | 0.400 | 0.100 | 0.050 |
| Lithium | Li | 4.10 | 4.20 | 0.500 | 0.200 | 0.200 | 0.050 |
| Magnesium | Mg | n/a | n/a | 0.040 | 0.070 | 0.070 | 0.010 |
| Manganese | Mn | 0.01 | 0.01 | 0.039 | 0.013 | 0.008 | 0.001 |
| Sodium | Na | 1.50 | 2.40 | 1.000 | 1.000 | 0.100 | 0.050 |
| Nickel | Ni | 0.01 | 0.01 | 0.001 | 0.002 | 0.002 | 0.001 |
| Phosphorus | P | n/a | n/a | 0.100 | 0.100 | 0.100 | 0.050 |
| Titanium | Ti | 3.30 | 2.80 | 1.200 | 1.400 | 1.400 | 1.300 |
| Zinc | Zn | n/a | n/a | 0.010 | 0.010 | 0.010 | 0.010 |

| | | | | | | |
|---|---|---|---|---|---|---|
| Total Elements, ppm | 33.88 | 32.07 | 18.62 | 12.26 | 10.94 | 10.02 |
| Total Elements, % | 0.0034 | 0.0032 | 0.0019 | 0.0012 | 0.0011 | 0.0010 |
| Purity of SiO₂, % | 99.9966 | 99.9968 | 99.9981 | 99.9988 | 99.9989 | 99.9990 |

Other filler materials that can be used for the primary filler material of the high purity filler include, but are not limited to, crystalline silica, barium sulfate, aluminosilicate microspheres, glass microspheres (man-made or otherwise), zirconia, alumina, boron nitride, titanium dioxide, silicon carbide, and synthetic diamond.

The high purity filler material of the gasket material described herein can also have a high temperature tolerance, meaning the filler will not degrade the other components of the gasket material (e.g, the PTFE component) when the gasket material is used at high operating temperatures. In some embodiments, the high purity filler material (such as the high purity quartz filler described herein) is capable of being used at temperatures of 500° F. or greater without degrading the PTFE component of the gasket material. Other previously known filler materials, such as silica carbide, are not suitable for high temperature operation since the silica carbide will degrade PTFE at these high temperature conditions.

Other components that can be included in the gasket material include zirconia microballoons, which can be included to improve compressibility and recovery while maintaining the desired purity levels.

In some embodiments, the gasket material described herein is manufactured using calendaring processing, which beneficially imparts a biaxial material properties to the gasket material. Previously known gasket materials are often manufactured using a stretching technique, which results in uniaxial material properties.

Once the gasket material is formed, typically in sheet form, gasket seals can be formed from the gasket material sheets, such as annular gasket seals. In some embodiments, the gasket seals formed from the gasket sheets can have a first major surface and a second major surface opposing the first major surface. In some embodiments, interconnected sealing ridges may protrude from either or both of the first and second major surfaces. The interconnected sealing ridges may define an array of indentations.

One benefit of the gasket material described herein is that gasket seals can be formed from long arcs of gasket material sheets. Several long arcs are arranged in the form of, for example, a large diameter seal, and the arcs are joined together using thermal bonding techniques. The ability to use thermal bonding techniques to bond together ends of arcs to form large diameter seals preserves the purity of the overall gasket material. Other seal forming techniques, such as the use of adhesives, can be avoided so as to not introduce further impurity into the seal.

Gasket material and seals formed therefrom exhibit excellent mechanical properties. Specifically, the gasket seals have good sealing properties, low creep functionality, and are chemically inert. Table 2 compares various properties of a gasket material formed in accordance with the gasket material described herein to a gasket material formed with expanded PTFE having no filler material.

TABLE 2

| | Full Density PTFE with | | Expanded PTFE with | |
|---|---|---|---|---|
| | High Purity Filler | | no Filler | |
| Density | 2.254 | g/cc | 0.9 | g/cc |
| Compressibility | 7.5% | | 45% | |
| (ASTM F36) | | | | |
| Recovery | 45% | | 14% | |
| (ASTM F36) | | | | |
| Tensile Strength | 22 | MPa | 31 | MPa |
| Across Grain | | | | |
| (ASTM F152) | | | | |

| | | | |
|---|---|---|---|
| Stress Retention | Superior to | 15 | MPa |
| (DIN 52913) | expanded PTFE | | |

As shown in Table 2 above, full density PTFE gaskets with high purity filler have more suitable mechanical properties, specifically recovery, that are advantageous in sealing applications. ASTM F36 is a common compressibility and recovery test for gasket material, and Table 2 illustrates that the gasket material of the present invention performs better under these test conditions than expanded PTFE with no filler.

Table 3 below shows the performance characteristics of 1/16 inch thick gaskets in accordance with the embodiments described herein at varying amounts of high purity filler (Filler 1 from Table 1).

TABLE 3

| | ASTM | Filler 1 | | |
|---|---|---|---|---|
| Property | Test | 41% | 43% | 45% |
| Thickness, in. | | 0.061 | 0.061 | 0.062 |
| Tensile, Long., psi | D-1708 | 3517 | 3738 | 2901 |
| Tensile, Trans., psi | D-1708 | 3193 | 3183 | 2942 |
| Elongation, Long., % | D-1708 | 275 | 274 | 236 |
| Elongation, Trans., % | D-1708 | 288 | 299 | 280 |
| Compressibility, % | F-36 | 6.3 | 6.7 | 7.7 |
| Recovery, % | F-36 | 54.4 | 49.2 | 45.4 |
| Specific Gravity | D-792 | 2.257 | 2.258 | 2.233 |
| Creep Relaxation, % | F-38 | 40 | 36.3 | 32.4 |
| DIN 3535, cc/min | DIN | 0.023 | 0.090 | 0.114 |

Table 4 below shows the performance characteristics of ⅛ inch thick gaskets in accordance with the embodiments described herein at varying amounts of high purity filler (Filler 1 from Table 1).

TABLE 4

| | ASTM | Filler 1 | | |
|---|---|---|---|---|
| Property | Test | 41% | 43% | 45% |
| Thickness, in. | | 0.125 | 0.126 | 0.122 |
| Tensile, Long., psi | D-1708 | 3150 | 3264 | 2809 |
| Tensile, Trans., psi | D-1708 | 2999 | 2951 | 2885 |
| Elongation, Long., % | D-1708 | 286 | 270 | 248 |
| Elongation, Trans., % | D-1708 | 309 | 323 | 286 |
| Compressibility, % | F-36 | 5.5 | 5.0 | 5.4 |
| Recovery, % | F-36 | 49.8 | 53.3 | 50.4 |
| Specific Gravity | D-792 | 2.256 | 2.255 | 2.235 |
| Creep Relaxation, % | F-38 | 60.1 | 58.7 | 53.4 |
| DIN 3535, cc/min | DIN | 0.023 | 0.023 | 0.023 |

Table 5 below shows the performance characteristics of 1/16 inch thick gaskets in accordance with the embodiments described herein at 45% high purity filler (Filler 2 from Table 1).

TABLE 5

| | | Filler 2 |
|---|---|---|
| Property | ASTM Test | 45% |
| Thickness, in. | | 0.064 |
| Tensile, Long., psi | D-1708 | 2752 |
| Tensile, Trans., psi | D-1708 | 2625 |
| Elongation, Long., % | D-1708 | 233 |
| Elongation, Trans., % | D-1708 | 241 |
| Compressibility, % | F-36 | 7.4 |
| Recovery, % | F-36 | 49.0 |
| Specific Gravity | D-792 | 2.248 |
| Creep Relaxation, % | F-38 | 34.5 |
| DIN 3535, cc/min | DIN | 0.136 |

Table 6 below shows the performance characteristics of ⅛ inch thick gaskets in accordance with the embodiments described herein at 45% high purity filler (Filler 2 from Table 1).

TABLE 6

| | | Filler 2 |
|---|---|---|
| Property | ASTM Test | 45% |
| Thickness, in. | | 0.127 |
| Tensile, Long., psi | D-1708 | 2717 |
| Tensile, Trans., psi | D-1708 | 2530 |
| Elongation, Long., % | D-1708 | 247 |
| Elongation, Trans., % | D-1708 | 245 |
| Compressibility, % | F-36 | 6.3 |
| Recovery, % | F-36 | 46.9 |
| Specific Gravity | D-792 | 2.244 |
| Creep Relaxation, % | F-38 | 53.5 |
| DIN 3535, cc/min | DIN | 0.023 |

Table 7 below provides a performance comparison between gaskets made from standard PTFE and gaskets made according to embodiments described herein.

TABLE 7

| | | | | | Filler 1 | | | Filler 2 |
|---|---|---|---|---|---|---|---|---|
| Property | ASTM Test | STANDARD PTFE | | | 41% | 43% | 45% | 45% |
| Thickness, in. | | 0.065 | 0.065 | 0.063 | 0.061 | 0.061 | 0.062 | 0.064 |
| Tensile, Long., psi | D-1708 | 5320 | 4575 | 4987 | 3517 | 3738 | 2901 | 2752 |
| Tensile, Trans., psi | D-1708 | 4680 | 4576 | 4403 | 3193 | 3183 | 2942 | 2625 |
| Elongation, Long., % | D-1708 | 343 | 348 | 321 | 275 | 274 | 236 | 233 |
| Elongation, Trans., % | D-1708 | 363 | 413 | 331 | 288 | 299 | 280 | 241 |
| Compressibility, % | F-36 | 17.4 | 15.5 | 14.8 | 6.3 | 6.7 | 7.7 | 7.4 |
| Recovery, % | F-36 | 44.2 | 54.0 | 51.4 | 54.4 | 49.2 | 45.4 | 49.0 |
| Specific Gravity | D-792 | 2.171 | 2.175 | 2.176 | 2.257 | 2.258 | 2.233 | 2.248 |
| Creep Relaxation, % | F-38 | 66.7 | 69.4 | 77.2 | 40 | 36.3 | 32.4 | 34.5 |

Table 8 below provides a performance comparison between gaskets made from modified PTFE and gaskets made according to embodiments described herein.

TABLE 8

| | ASTM | | | | Filler 1 | | | Filler 2 |
|---|---|---|---|---|---|---|---|---|
| Property | Test | MODIFIED PTFE | | | 41% | 43% | 45% | 45% |
| Thickness, in. | | 0.062 | 0.061 | 0.060 | 0.061 | 0.061 | 0.062 | 0.064 |
| Tensile, Long., psi | D-1708 | 4363 | 5418 | 5083 | 3517 | 3738 | 2901 | 2752 |
| Tensile, Trans., psi | D-1708 | 4987 | 5172 | 4672 | 3193 | 3183 | 2942 | 2625 |
| Elongation, Long., % | D-1708 | 372 | 443 | 517 | 275 | 274 | 236 | 233 |
| Elongation, Trans., % | D-1708 | 410 | 415 | 464 | 288 | 299 | 280 | 241 |
| Compressibility, % | F-36 | 29.6 | 32.6 | 27.8 | 6.3 | 6.7 | 7.7 | 7.4 |
| Recovery, % | F-36 | 54.1 | 45.8 | 43.5 | 54.4 | 49.2 | 45.4 | 49.0 |
| Specific Gravity | D-792 | 2.149 | 2.153 | 2.167 | 2.257 | 2.258 | 2.233 | 2.248 |
| Creep Relaxation, % | F-38 | 60.3 | 58.7 | 57.3 | 40 | 36.3 | 32.4 | 34.5 |

Table 9 below provides a performance comparison between gaskets made from expanded PTFE and gaskets made according to embodiments described herein.

TABLE 9

| | | POROUS | | | Filler 1 | | Filler 2 | |
|---|---|---|---|---|---|---|---|---|
| Property | ASTM Test | EXPANDED Eptfe | | | 43% | 43% | 45% | 45% |
| Thickness, in. | | 0.123 | 0.134 | 0.123 | 0.126 | 0.123 | 0.127 | 0.126 |
| Tensile, Long., | D-1708 | 6036 | 3976 | 2794 | 3264 | 2887 | 2717 | 2809 |
| psi | | | | | | | | |
| Tensile, Trans., | D-1708 | 5567 | 3725 | 2765 | 2951 | 2928 | 2530 | 2566 |
| psi | | | | | | | | |
| Elongation, | D-1708 | 127 | 216 | 254 | 270 | 268 | 247 | 251 |
| Long., % | | | | | | | | |
| Elongation, | D-1708 | 109 | 181 | 213 | 323 | 306 | 245 | 269 |
| Trans., % | | | | | | | | |
| Compressibility, % | F-36 | 60.7 | 64.6 | 67.8 | 5 | 5.1 | 6.3 | 5.4 |
| Recovery, % | F-36 | 11.3 | 11.8 | 12.1 | 53.3 | 54.0 | 46.9 | 52.7 |
| Specific Gravity | D-792 | 0.695 | 0.652 | 0.700 | 2.255 | 2.250 | 2.244 | 2.248 |
| Creep | F-38 | 63.4 | 61.5 | 72.7 | 58.7 | 60.2 | 53.5 | 57.3 |
| Relaxation, % | | | | | | | | |
| Sealability, | F37 | n/a | n/a | 2.378 | n/a | 0.253 | n/a | 0.500 |
| Nitrogen, | | | | | | | | |
| ml/hr. | | | | | | | | |
| Sealability, Fuel | F37B | 0.675 | 0.750 | 3.000 | n/a | 0.199 | n/a | 0.320 |
| A, ml/hr. | | | | | | | | |

One exemplary, non-limiting application for the gasket material described herein is in the production of polysilicon. Polysilicon is a raw material used extensively in the solar photovoltaic and electronics industries. More specifically, polysilicon is used in solar cells and solar module manufacturing within the solar photovoltaic industry, and in semiconductor silicon chips within the electronics industry. For polysilicon to be suitable for use in these industries, it must have an extremely high degree of purity. For example, solar-grade polysilicon typically requires purity levels of 99.9999% (6N) to 99.999999% (8N), while electronics-grade polysilicon typically requires purity levels of 99.9999999% (9N) to 99.99999999999% (11N). Use of the gasket material described herein in the manufacture of polysilicon can help to achieve these polysilicon purity levels as discussed in greater detail below.

Polysilicon is produced from metallurgical-grade silicon. As part of the process of producing polysilicon from metallurgical grade silicon, the metallurgical silicon must be purified to bring any impurities down to a parts per billion (ppb) level. One purification method commonly used is the Siemens process. In this process, metallurgical silicon is first reacted with HCl at 300° C. in a fluidized bed reactor to convert the metallurgical silicon to trichlorosilane. The trichlorosilane produced from the metallurgical silicon is of a very high purity, but is still subjected to distillation in order to further increase the trichlorosilane to ultra-pure trichlorosilane. This ultra-pure trichlorosilane is then vaporized, diluted with H₂, and flowed into a deposition reactor where it is retransformed into high purity polysilicon (i.e., polysilicon having purity levels in the range of 6N to 11N).

As can be understood from the above brief description of the manner in which high purity polysilicon is formed, the movement of materials (e.g., trichlorosilane, polysilicon, etc.) through processing equipment is required as part of the manufacturing process. As such, gasket seals are required for sealing together, for example, fluid transport piping, storage tanks, and reactor chambers. For example, in some embodiments, a reactor chamber used for polysilicon manufacture comprises a large dome formed from two identical sections that are sealed together along a diameter of the dome. A gasket seal is required to seal together these two sections.

In order to retain the critical high purity of the materials moving through the processing equipment, high purity gasket seals must be used in order to prevent the leaching of contaminants into the high purity materials. At the same time, high purity gasket materials must also possess mechanical functionality and chemical compatibility. Gasket seals made from the gasket material described herein are capable of providing the level of purity, mechanical functionality and chemical compatibility required for polysilicon manufacturing. An additional benefit can be the reusability of gasket seals formed from the gasket material described herein.

In some embodiments of the polysilicon manufacturing method, pipe gaskets having diameters in the range of from 1″ to 24″ and reactor gaskets having diameters in the range of from 48″ to 120″ are required. Forming large diameter gasket seals generally requires adhering together smaller arcs of gasket material. As described above, the gasket material described herein is capable of being thermally bonded together to form large diameter gasket seals without the need for, for example, an adhesive. The ability to eliminate adhesive from the gasket seal ensures the purity of the gasket seal remains high and therefore suitable for use in, e.g., polysilicon manufacture.

In view of the above, the present application is also directed to a system for the product of polysilicon, wherein the gasket material described herein is used to form gasket seals that are used to seal components of the system for the production of polysilicon. Exemplary seal locations include between flanges of adjacent pipe segments, between a pipe segment and a storage tank, and between a pipe segment and a reaction chamber.

From the foregoing, it will be appreciated that specific embodiments of the invention have been described herein for purposes of illustration, but that various modifications may be made without deviating from the scope of the invention. Accordingly, the invention is not limited except as by the appended claims.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended.

Unless otherwise indicated, all number or expressions, such as those expressing dimensions, physical characteristics, etc., used in the specification (other than the claims) are understood as modified in all instances by the term “approximately”. At the very least, and not as an attempt to limit the application of the doctrine of equivalents to the claims, each numerical parameter recited in the specification or claims which is modified by the term “approximately” should at least be construed in light of the number of recited significant digits and by applying rounding techniques. Moreover, all ranges disclosed herein are to be understood to encompass and provide support for claims that recite any and all sub-ranges or any and all individual values subsumed therein. For example, a stated range of 1 to 10 should be considered to include and provide support for claims that recite any and all sub-ranges or individual values that are between and/or inclusive of the minimum value of 1 and the maximum value of 10; that is, all sub-ranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

I/We claim:

1. A gasket material comprising:
50 to 60 wt % polytetrafluoroethylene; and
40 to 50 wt % filler, wherein the filler includes greater than or equal to 99.996% of primary filler material and less than or equal to 0.004% contaminants.

2. The gasket material of claim 1, wherein the polytetrafluoroethylene is full density polytetrafluorethylene.

3. The gasket material of claim 2, wherein the primary filler material is quartz.

4. The gasket material of claim 3, wherein the gasket material consists of the polytetrafluorethylene and the filler.

5. The gasket material of claim 3, wherein the polytetrafluorethylene is in the form of a matrix and the filler is homogenously dispersed throughout the polytetrafluoroethylene matrix.

6. The gasket material of claim 3, wherein the filler is at least 99.999% quartz.

7. The gasket material of claim 3, further comprising zirconia microballoons.

8. The gasket material of claim 3, wherein the gasket material is manufactured in a manner that results in the gasket material having biaxial material properties.

9. The gasket material of claim 3, wherein the gasket material is provided in the form of an annular gasket seal.

10. A method of manufacturing an annular gasket seal comprising:
providing a sheet of gasket material comprising:
50 to 60 wt % full density polytetrafluoroethylene; and
40 to 50 wt % filler, wherein the filler comprises greater than or equal to 99.996% primary filler material;
cutting a series of arcs from the sheet of gasket material;
arranging the series of arcs in a circle; and
thermally bonding the ends of adjacent arcs.

11. The method claim 10, wherein the primary filler material is quartz.

12. The method of claim 10, wherein prior to cutting arcs from the sheet of gasket material, the sheet of gasket material is calendared in a manner that provides the gasket material sheet with biaxial material properties.

13. The method of claim 10, wherein thermally bonding the ends of the adjacent arcs is carried out in the absence of adhesive.

14. A system for manufacturing high purity polysilicon, comprising:
a first system component;
a second system component abutting and in fluid communication with the first system component; and
a gasket seal disposed between the first system component and the second system component, the gasket seal comprising:
50 to 60 wt % full density polytetrafluoroethylene; and
40 to 50 wt % filler, wherein the filler comprises greater than or equal to 99.996% primary filler material;

15. The system of claim 14, wherein the primary filler material is quartz.

16. The system of claim 14, wherein the first system component is a pipe segment and the second system component is a reaction chamber.

17. The system of claim 14, wherein the first system component is one half of a dome-shaped reaction chamber and the second system component is a second half of the dome-shaped reaction chamber.
